(19) United States
(12) Patent Application Publication
(10) Pub. No.: US 2005/0270902 A1
(43) Pub. Date: Dec. 8, 2005

(54) Method and apparatus for measuring an ambient water velocity near a deflector device

(76) Inventor: Rune Tonnessen, Oslo (NO)

Correspondence Address: MARK W. SINCELL;Williams, Morgan & Amerson, P.C., Suite 1100, 10333 Richmond, Houston, TX, 77042, US

(21) Appl. No.: 10/863,321

(22) Filed: Jun. 8, 2004

(51) Int. Cl. G01V 1/38

(52) U.S. Cl. 367/23

(57) ABSTRACT

The present invention provides a method and apparatus for determining an ambient water velocity using a measurement device deployed in, on, or proximate to a hydrofoil. The method includes deploying a measurement device in, on, or proximate to a hydrofoil and determining an ambient water velocity using the measurement device.

### BACKGROUND OF THE INVENTION

1. Field of the Invention

This invention relates generally to marine seismic surveying, and, more particularly, to measuring an ambient water velocity near a deflector unit in a marine seismic survey.

2. Description of the Related Art

Marine seismic exploration is widely used to locate and/or survey subterranean geological formations for hydrocarbon deposit because many hydrocarbon deposits are found beneath bodies of water. FIG. 1 conceptually illustrates a conventional system 100 for carrying out a marine seismic survey. The conventional system 100 includes a survey vessel 105 coupled to a seismic array 110, which typically include one or more streamers 120. One or more seismic sensors 125, such as hydrophones, may be distributed along the length of the seismic streamer 120. Although not shown in FIG. 1, one or more seismic sources may also be included within the conventional system 100. For example, one or more seismic sources ay be towed by the survey vessel 105, towed by another vessel (not shown), suspended beneath buoys (not shown), deployed on the sea floor, and the like.

In operation, the survey vessel 105 tows the seismic array 110 along a predetermined path. As the seismic array 110 passes over a selected region of the sea floor, the seismic sources may be used to drive an acoustic wave, commonly referred to as a “shot,” through the overlying water and into the ground beneath the selected region of the sea floor. The acoustic wave may be reflected by subterranean geologic formations and propagate back to the seismic sensors 125. The seismic sensors 125 receive the reflected waves, which are then processed to generate seismic data. Analysis of the seismic data may indicate probable locations of geological formations such as hydrocarbon deposits.

The accuracy of the seismic survey is determined, in part, by how accurately the seismic array 110 is towed along the predetermined path. Many factors, including water currents, may cause the seismic array 110 and/or one or more streamers 120 to deviate from the predetermined path. Thus, the seismic array 110 is typically guided by steering the survey vessel 105 and by providing one or more hydrofoils 135 coupled to the seismic array 110. For example, one or more Western Geco Monowings® may be coupled to the seismic array 110. The hydrofoils 135 may provide lift as they are towed through the water by the survey vessel 105. For example, a hydrofoil 135 used as a deflector device in a seismic survey may have a lift of about 10 tons. The lift provided by the hydrofoils 135 may be used to maintain a spread of the streamers 120 of the seismic array 110 and, in some cases, may be used to steer the path of the seismic array 110.

The lift of the hydrofoil 135 is approximately proportional to an angle of attack 140 of the hydrofoil 135. The angle of attack 140 of the hydrofoil 135 is the angle between a line 145 and a water velocity vector 160 near the hydrofoil 135 seen in reference to the hydrofoil 135. In the illustrated embodiment, the line 145 is defined as a line extending from a tip 150 to a tail 155 of the hydrofoil 135. However, persons of ordinary skill in the art should appreciate that the line 145 may be defined in many different ways. In one alternative embodiment, the line 145 is defined as being parallel to a flat side of a pressure side of the hydrofoil 135, Hereinafter, the water velocity vector 160 near the hydrofoil 135 will be referred to as the ambient water velocity 160. In accordance with common usage in the art, the ambient water velocity 160 is defined herein as the velocity relative to the hydrofoil 135 that water at the location of the hydrofoil 135 would have in the absence of the hydrofoil 135. The lift of the hydrofoil 135 is also approximately proportional to a square of a magnitude of the ambient water velocity 160. However, conventional marine seismic survey systems 100 typically operate without knowing the ambient water velocity 160 and/or the angle of attack 140. Consequently, conventional marine seismic survey systems 100 typically operate without knowing the actual lift provided by the hydrofoil 135.

For example, in a conventional marine seismic survey system 100, the survey vessel 105 may be equipped with a hull-mounted Doppler current meter (not shown) to measure a water velocity 165 near the survey vessel 105. The water velocity 165 may then be used to estimate the lift provided by the hydrofoil 135. However, the hull-mounted Doppler current meter does not provide reliable measures of the water velocity 165 at depths less than about 20 meters and the water velocity typically changes in the 10-20 meters closest to the sea surface. Thus, the conventional hull-mounted current meter may not provide a reliable measure of the ambient water velocity 160 near the hydrofoils 135 and/or the seismic streamers 120, which are typically towed at depths ranging from about 4 to 8 meters. Furthermore, the width of the seismic array 110 may exceed 1 km and therefore the ambient water velocity 160 may be significantly different than the water velocity 165 near the survey vessel 105.

The conventional techniques for estimating the lift, either by using no water velocity information or by using the water velocity 165 as an estimate of the ambient water velocity 160, may also be insufficient for use in survey control systems that include the hydrofoil 135. For example, the depth of the hydrofoil 135 may be controlled through a control loop that controls the tilt of the hydrofoil 135. For another example, the seismic array 110 may be actively steered using the survey vessel 105 and the hydrofoil 135 and one or more birds (not shown) that may be mounted on the streamer 120. However, the effectiveness of these techniques may be reduced by uncertainties in the angle of attack 140 and/or the ambient water velocity 160 near the hydrofoils 135.

The hydrofoil 135 has a preferred operational range for the angle of attack typically defined by an upper and lower limit to the angle of attack 140. Operating the hydrofoil 135 at attack angles 140 below the lower limit causes unstable behavior of the hydrofoil 135, and operating the hydrofoil 135 at attack angles 140 that exceed the upper limit, typically referred to as a stall angle, causes the hydrofoil 135 to stall, potentially resulting in a decrease in lift, abrupt increase in drag, instability, and the like. In some cases, stalling may cause the hydrofoil 135 to come to the surface. When actively steering the front end, the hydrofoil 135 may be operated in a broad range of attack angles 140, depending on the situation, and the likelihood of exceeding these limitations may increase.

Structural limitations may also put restrictions on maximum values of the ambient water velocity 160 and/or the angle of attack 140. In one embodiment, portions of the hydrofoil 135 may be deformed by forces, such as lift forces and drag forces, placed upon the hydrofoil 135 during operation. For example, the hydrofoil 135 may experience plastic deformation, cracking, breaking, de-lamination of composite materials, and the like. The lift force is proportional to the angle of attack 140 and the drag force is approximately proportional to the square of the angle of attack 140. Both the lift and drag forces are proportional to the square of the ambient water velocity 160. Accordingly, the limits on the maximum lift and/or drag forces correspond to restrictions on the angle of attack 140 and/or the magnitude of the ambient water velocity 160.

Rip currents, which have very large current gradients in the vertical direction, may also cause the hydrofoil 135 to rise to the water surface. Furthermore, during streamer stacking and other operational modes of the streamers 120, rip current information is vital for efficient operation. For example, rip current information may be particularly useful in avoiding tangling of the streamers 120. However, the conventional hull-mounted current meter discussed above measures the water currents below the depths at which the rip currents typically form. Thus, the conventional hull mounted current meter only provides information regarding current gradients at locations deeper than the hull.

The present invention is directed to addressing the effects of one or more of the problems set forth above.

### SUMMARY OF THE INVENTION

In one embodiment of the instant invention, a method is provided for determining an ambient water velocity using a measurement device deployed in, on, or proximate to a hydrofoil. In another embodiment of the present invention, an apparatus is provided for determining an ambient water velocity using a measurement device deployed in, on, or proximate to a hydrofoil.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a prior art system for carrying out a marine seismic survey;

FIG. 2 conceptually illustrates a top-down view of an exemplary embodiment of a hydrofoil;

FIG. 3 conceptually illustrates a Doppler log that may be used with the hydrofoil shown in FIG. 2;

FIGS. 4A and 4B conceptually illustrate a frontal view and a side view, respectively, of an exemplary embodiment of a Pitot tube;

FIG. 5 conceptually illustrates an exemplary embodiment of a hydrofoil that operates based on the same principles as a Pitot tube;

FIG. 6 conceptually illustrates a pressure distribution over a two-dimensional hydrofoil;

FIG. 7 conceptually illustrates a lift coefficient as a function of an angle of attack;

FIGS. 8A and 8B conceptually illustrate first and second embodiments of a system for determining a variation in an ambient water velocity by water depth; and

FIG. 9 conceptually illustrates one embodiment of a system that may be used to determine a water current proximate a hydrofoil.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

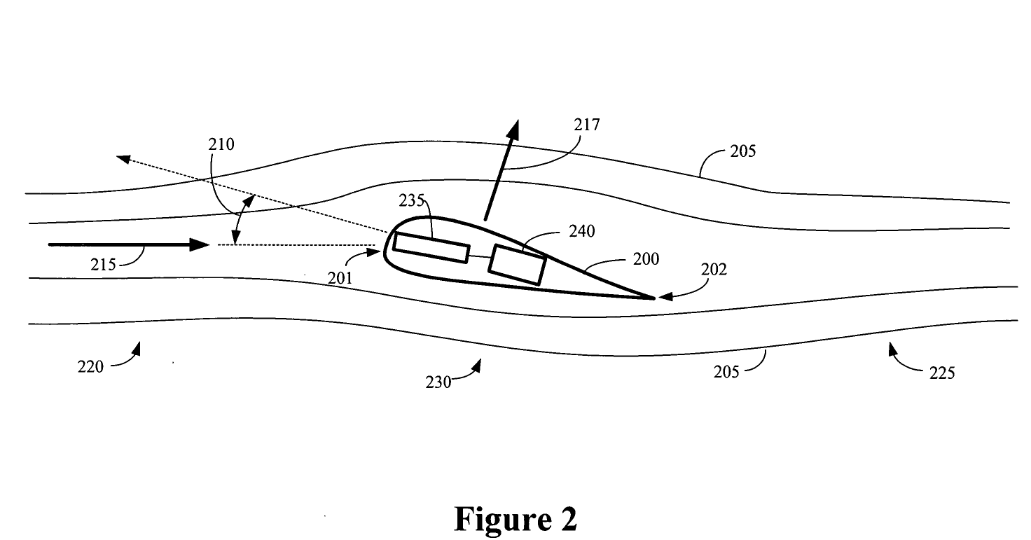

FIG. 2 conceptually illustrates a top-down view of an exemplary embodiment of a hydrofoil 200. In the illustrated embodiment, the hydrofoil 200 is a deflector device, such as Western Geco's Monowing®, which may be used in a marine seismic survey. However, persons of ordinary skill in the art should appreciate that the present invention is not limited to the Monowing® and that the hydrofoil 200 is intended to be representative of deflector devices that may be used throughout the seismic industry. Moreover, the present invention is not limited to hydrofoils 200 that are used in marine seismic surveys. In alternative embodiments, the present invention may be implemented in any desirable context. The dimensions of the hydrofoil 200 may be characterized by at least a height, measured in a direction into the page in FIG. 2, and a length measured from a nose 201 to a tail 202 of the hydrofoil 200. In accordance with common usage in the art, the length measured from the nose 201 to the tail 202 is referred to hereinafter as a chord length. For example, one embodiment of Western Geco's Monowing® has a height of about 7.5 meters and a chord length of approximately 1-2 meters.

In operation, the hydrofoil 200 travels through a fluid, indicated by the stream lines 205. In the interest of clarity, only four streamlines 205 are indicted in FIG. 2. In one embodiment, the fluid is sea water. However, the present invention is not limited to sea water and in alternative embodiments the fluid may be freshwater, brackish water, and the like. The hydrofoil 200 is oriented so that it has an angle of attack 210 that is measured with respect to the ambient water velocity 215. As used herein, the term “velocity” will be understood to refer to a vector that indicates both the speed of the ambient water, i.e. the magnitude of the ambient water velocity 215, and the direction of the ambient water velocity 215, both with reference to the hydrofoil 200.

As the hydrofoil 200 travels through the fluid, lift 217 may be generated in a direction that is approximately perpendicular to the ambient water velocity 215. Persons of ordinary skill in the art should appreciate that the lift 217 shown in FIG. 2 includes the lift force perpendicular to the ambient water velocity and the drag force parallel to the ambient velocity. However, and interest of clarity, a combined lift and drag forces will be referred to hereinafter as the lift 217. As discussed above, the lift 217 is approximately proportional to the angle of attack 210. The lift 217 may also be proportional to a square of a magnitude of the ambient water velocity 215.

The stream lines 205 are disturbed by the passing hydrofoil 200. For example, the stream lines 205 in the far leading and far trailing regions 220, 225, respectively, may be substantially undisturbed by the hydrofoil 200, as indicated by the approximately parallel stream lines 205. However, the stream lines 205 may be disturbed in a region 230 closer to the hydrofoil 200, as indicated by the deviations in the stream lines 205 shown in FIG. 2. Persons of ordinary skill in the art should appreciate that no precise boundary exists between the undisturbed regions 220, 225 and the disturbed region 230, and that the physical extent of the regions 220, 225, 230 may depend on the velocity of the hydrofoil 200, the angle of attack 210, the ambient water velocity 215, and the like.

The hydrofoil 200 includes a measurement unit 235 for determining the ambient water velocity 215. In the illustrated embodiment, the measurement unit 235 is integrated into the hydrofoil 200. However, the present invention is not limited to having the measurement unit 235 integrated into the hydrofoil 200. In alternative embodiments, the measurement unit 235 may be mounted at any desirable place in or on the hydrofoil 200. For example, the measurement unit 235 may be attached to the hydrofoil 200 by a bracket (not shown). However, persons of ordinary skill in the art should appreciate that the measurement unit 235 may be deployed anywhere proximate to the hydrofoil 200. As used herein, the term “proximate” means that the measurement unit 235 is deployed such that it may determine the ambient water velocity 215, i.e. the water velocity in one or more of the regions 220, 225, 230 and even below the hydrofoil 200. As will be discussed in detail below, the measurement unit 235 may include a Doppler log, a Pitot tube, one or more openings in the hydrofoil 200, and the like.

The measurement unit 235 determines the ambient water velocity 215 proximate the hydrofoil 200. In one embodiment, the measurement unit 235 determines the ambient water velocity 215 in a region that is substantially undisturbed by the presence of the hydrofoil 200, such as the leading region 220. However, in alternative embodiments, the measurement unit 235 may determine the ambient water velocity 215 in a region that is disturbed by the presence of the hydrofoil 200, such as the region 230. For example, the measurement unit 235 may determine the ambient water velocity 215 at or near a surface of the hydrofoil 200.

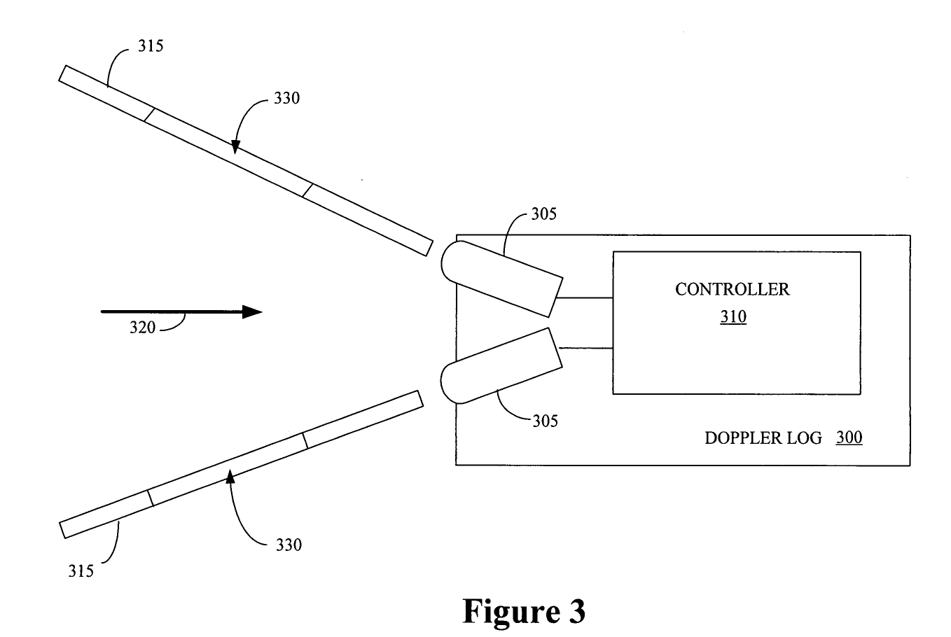

FIG. 3 conceptually illustrates a Doppler log 300 that may be used as at least a portion of the measurement unit 235 shown in FIG. 2. The Doppler log 300 includes at least one beam unit 305. In the illustrated embodiment, the Doppler log 300 includes two beam units 305. However, persons of ordinary skill in the art should appreciate that, in alternative embodiments, the Doppler log 300 may include more or fewer beam units 305. For example, a three-dimensional Doppler log 300 would include at least three beam units 305. The beam units 305 are coupled to a controller 310.

The beam units 305 provide corresponding beams 315, which are reflected by particles in the water. For example, the beams 315 may be reflected by algae in the water at a range of about 1-15 meters. The beam units 305 detect at least a portion of the reflected beams 315 and provide a signal indicative of the velocity of the particles in the water, which is indicative of the velocity of the water exposed to the beams 315, to the controller 310. For example, the beam units 305 may provide a signal indicative of a Doppler shift in one or more frequencies of the beams 315. The controller 310 uses the one or more signals provided by the beam units 305 to determine an ambient water velocity 320. In one embodiment, the controller 310 may combine two scalar values indicative of a component of the water velocities in line with each beam 315 to determine the ambient water velocity vector 320. In one alternative embodiment, the controller 310 may use the two signals provided by the two beam units 305 shown in FIG. 3 to determine a component of the ambient water velocity 320 perpendicular to a leading edge of a hydrofoil (not shown in FIG. 3).

In one embodiment, the beam units 305 in the Doppler log 300 may be tuned to measure the ambient water velocity 320 in selected beam regions or columns 330. For example, the beam units 305 may be tuned to measure the ambient water velocity 320 in the selected beam regions 330 that approximately correspond to an undisturbed region located at a distance that is further than about two chord lengths from the Doppler log 300. In alternative embodiments, the Doppler log 300 may also determine the ambient water velocity 320 by averaging measurements taken over a plurality of beam columns 330. A starting column and an ending column may also be selected to determine the columns 330 over which the average is taken.

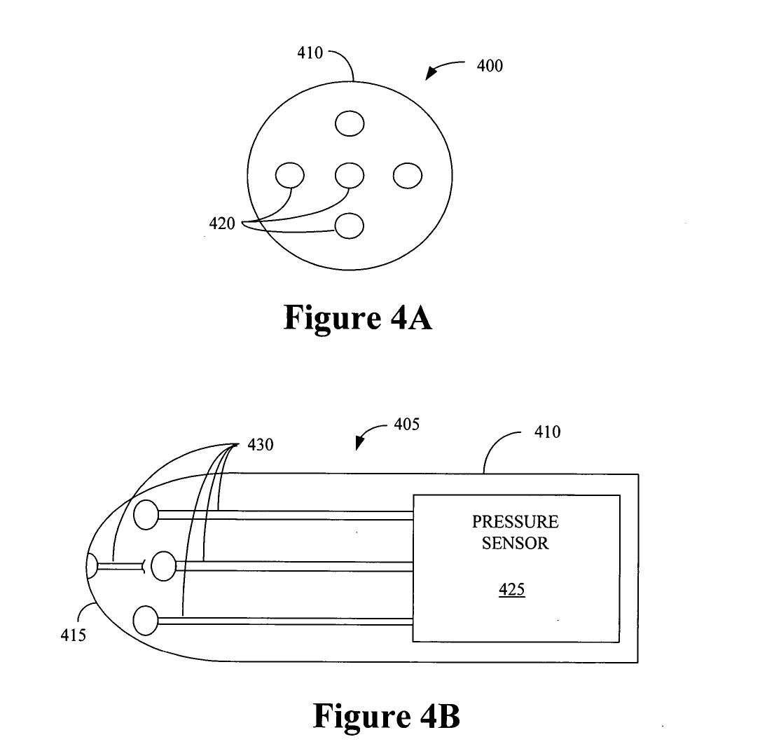

FIGS. 4A and 4B conceptually illustrate a frontal view 400 and a side view 405, respectively, of an exemplary embodiment of a Pitot tube 410 that may be used as the measurement device 235 shown in FIG. 2. The exemplary embodiment of the Pitot tube 410 is generally cylindrical with one end 415 being approximately in the shape of a half sphere. A plurality of openings 420 are provided proximate the end 415. In the illustrated embodiment, five openings 420 are distributed approximately symmetrically about a cylindrical axis of the Pitot tube 410. However, persons of ordinary skill in the art should appreciate that the present invention is not limited to five openings 420 distributed symmetrically about the cylindrical axis of the Pitot tube 410. In alternative embodiments, any desirable number of openings 420 may be provided and distributed in any desirable manner and the geometry of the Pitot tube 410 may be varied.

The openings 420 are connected to a pressure sensor 425 by a corresponding number of tubes 430. However, the present invention is not limited to using tubes 430. In alternative embodiments, any desirable technique for conveying the pressure sensed at the openings 420 to the pressure sensor 425, including hoses, open spaces, hydraulic elements, and the like, may be used. In one embodiment, the pressure sensor 425 may determine one or more absolute water pressures at the one or more openings 420. However, the present invention is not limited to determining absolute water pressures. In alternative embodiments, the pressure sensor 425 may determine one or more relative water pressures at the one or more openings 420. In one embodiment, the openings 420 may be sealed with flexible diaphragms or other pressure-transmitting surfaces and/or membranes to prevent water from entering the openings 420.

The Pitot tube 410 may be calibrated so that it is capable of determining an ambient water velocity, such as the ambient water velocity 215 shown in FIG. 2, proximate a hydrofoil based upon the pressures sensed at the openings 420. In one embodiment, the pressure sensor 425 determines the ambient water velocity using a known relation between the pressure at the one or more openings 420 and the ambient water velocity. For example, the pressure sensor 425 may determine the ambient water velocity by applying a relation between the measured pressures at the openings 420 and the ambient water velocity given by Bernoulli's equation. Accordingly, the Pitot tube 410 may be calibrated to determine one or more parameters of the known relation, such as one or more coefficients in Bernoulli's equation. The Pitot tube 410 may also be calibrated to correct for the disturbances in the flow caused by the Pitot tube 610 and/or the hydrofoil. The pressure sensor 425 may then determine the ambient water velocity based on the pressures sensed at the openings 420, the known relation, and the calibration.

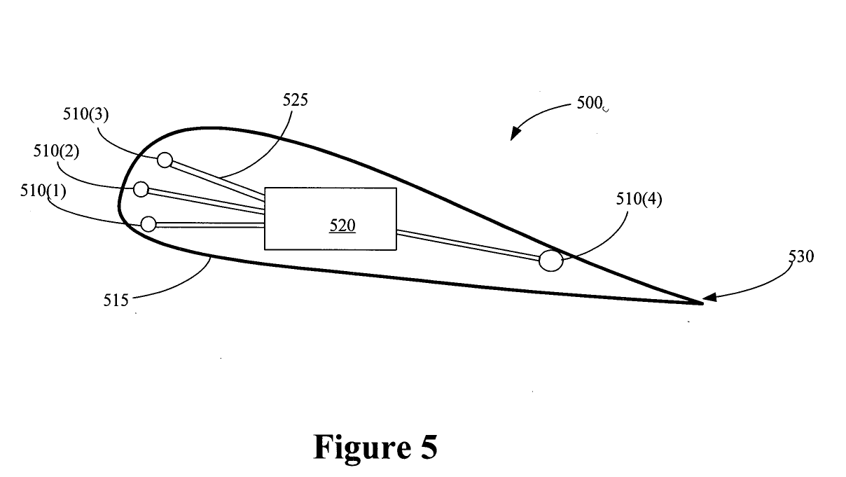

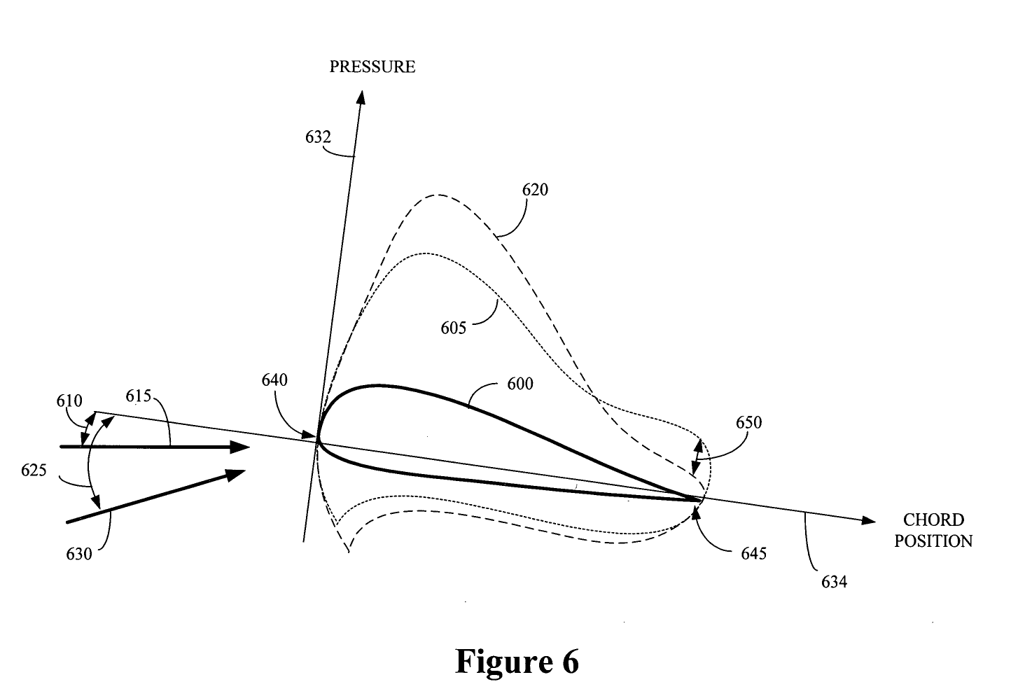

FIG. 5 conceptually illustrates an exemplary embodiment of a hydrofoil 500 that may be used as the measurement device 235 shown in FIG. 2. The exemplary embodiment of the hydrofoil 500 may be used as an alternative to, or in combination with, the exemplary embodiment of the Pitot tube 410 shown in FIG. 4. In the exemplary embodiment, one or more openings 510(1-3) are formed in the surface 515 of the hydrofoil 500. The openings 510(1-3) are coupled to a pressure sensor 520 by a corresponding plurality of tubes 525. Consequently, the hydrofoil 500 may be considered to function as a Pitot tube. The pressure sensor 520 operates in a manner similar to the pressure sensor 425 shown in FIG. 4, and so will not be discussed further. In the illustrated embodiment, the opening 510(3) may be formed proximate a tail 530 of the hydrofoil 500. As discussed in detail below with regard to FIG. 6, forming the opening 510(3) proximate the tail 530 may permit the Hydrofoil 500 to more accurately determine the normal operating range of the hydrofoil 500.

FIG. 6 conceptually illustrates a pressure distribution over a two-dimensional hydrofoil 600 for embodiments such as those shown in FIGS. 4A, 4B, and 5. In the illustrated embodiment, a first pressure distribution 605 results when the hydrofoil 600 is operating at a moderate angle of attack 610 relative to an ambient water velocity 615 and a second pressure distribution 620 results when the hydrofoil 600 is operating at a high angle of attack 625 relative to an ambient water velocity 630. The pressure distributions 605, 620 are measured relative to a first axis 632 indicative of the pressure and a second axis 634 indicative of a chord position, i.e. a distance along a direction from a nose 640 to a tail 645 of the hydrofoil 600.

In both cases, the first and second pressure distributions 605, 620 change most rapidly close to the nose 640 of the hydrofoil 600. Accordingly, the relationship between the pressure distribution 605, 620 and the ambient water velocity 610, 625 may be more clearly defined close to the nose 640 and measurements of the pressure distribution 605, 620 proximate the nose 640 may result in a more accurate determination of the ambient water velocity 610, 625. In the illustrated embodiment, the angle of attack 625 is close to a stall angle of the hydrofoil 600 and the second pressure distribution 620 exhibits a pressure drop 650 near the tail 634, relative to the first pressure distribution 605. The pressure drop 650 may lead to stalling near the tail 745. Accordingly, measurements of the pressure distribution 605, 620 proximate the tail 634 may improve the accuracy of a stall indicator that determines a normal operational range of the angle of attack 610, 625 of the hydrofoil 600.

Referring again to FIG. 2, the measurement device 235 provides information indicative of the ambient water velocity 215 to a processing unit 240. The processing unit 240 may comprise a computing device running software that implements some of the operations described below. Persons of ordinary skill in the art should appreciate that the processing unit 240 may be any kind of processor known to the art, such as a digital signal processor, operating on any kind of suitable operating system known to the art.

In the embodiment illustrated in FIG. 2, at least a portion of the processing unit 240 is deployed within the hydrofoil 200. However, persons of ordinary skill in the art should appreciate that the present invention is not limited to embodiments with the processing unit 240 is deployed within the hydrofoil 200. In alternative embodiments, portions of the processing unit 240 may be deployed at any desirable location including a survey vessel, a streamer, and the like. For example, the processing unit may be part of a control loop that is operated from on board a survey vessel (not shown). The processing unit 240 is configured to use the information indicative of the ambient water velocity 215 to determine various quantities related to the operation of the hydrofoil 200, as will be discussed in detail below.

In one embodiment, the processing unit 240 determines the angle of attack 210 based upon the ambient water velocity 215 determined by the measurement device 235. The processing unit may then determine the lift 217 of the hydrofoil 200 based upon the angle of attack 210 and the magnitude of the ambient water velocity 215. In one embodiment, the processing unit 240 determines the lift 217 using a known relation between the lift 217 and the angle of attack 210 of the hydrofoil 200 and the magnitude of the water velocity. However, in alternative embodiments such as those shown in FIGS. 4A, 4B, 5, and 6, the processing unit 240 may determine the lift 217 by determining the pressure at one or more holes 420, 510(1-3). The processing unit 240 determines a relation between the measured pressure distribution and the magnitude and/or orientation of the ambient velocity vector 215 relative to the angle of attack 210 using the calibration. The lift 217 is then determined using the magnitude of the ambient velocity vector 215 and the orientation of the ambient velocity vector 215 relative to the hydrofoil 200, i.e. the angle of attack 210.

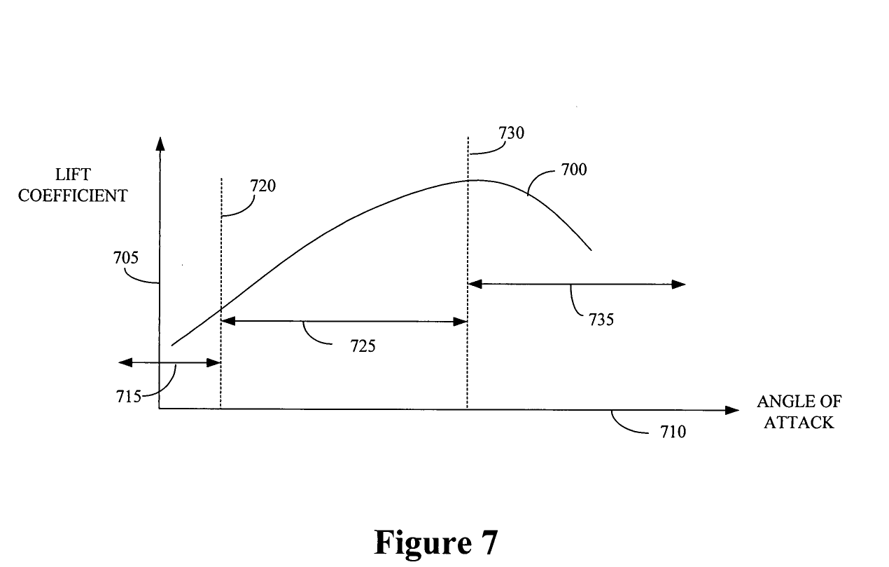

FIG. 7 conceptually illustrates a lift 700 of a hydrofoil as a function of an angle of attack. In FIG. 7, the lift 700 is measured along a vertical axis 705 and the angle of attack is measured along a horizontal axis 710. A wobble region 715 is located below a first angle of attack indicated by the dotted line 720. In the wobble region 715, the lift 700 may be insufficient, which may lead to undesirable instabilities in the hydrofoil. The lift 700 may be sufficient for stable operation in the normal operating region 725 located approximately between the first angle of attack 720 and a second angle of attack 730. A stall region 735 is located approximately above the second angle of attack 725. Operating a hydrofoil in the stall region 735 is generally considered undesirable. For example operating the hydrofoil in the stall region 735 may cause the hydrofoil to stall, resulting in a decrease in lift, an abrupt increase in drag, instabilities of the hydrofoil, and the like. In some cases, operating the hydrofoil in the stall region 735 may also cause the hydrofoil to come to the surface.

Referring again to FIG. 2, in one embodiment, the processing unit 240 may be configured to determine a normal operational range of the angle of attack 210 of the hydrofoil 200 based upon the lift 217. For example, the processing unit 240 may determine that the hydrofoil 200 is operating at an angle of attack 210 that is in a normal operating range based upon the lift 217. However, the processing unit 240 may determine that the hydrofoil 200 is not operating at an angle of attack 210 that is in the normal operating range based upon the lift 217. For example the processing unit 240 may determine that the hydrofoil 200 is operating at an angle of attack 210 that is in a wobble region or in a stall region, such as the wobble region 720 or the stall region 730 shown in FIG. 7.

In one embodiment, the processing unit 240 may provide a signal indicating that the hydrofoil 200 is operating at an angle of attack 210 that is, or is not, in the normal operating region. The provided signal may be used by an active steering system (not shown) to control the hydrofoil 200. For one example, the angle of attack 210 may be varied so that it is in the normal operating region. For another example, the lift 217 of the hydrofoil 200 may be controlled to thereby control a lateral position of the seismic streamer so as to position the streamer on a pre-defined track, e.g. for time-lapse/4D seismic surveying.

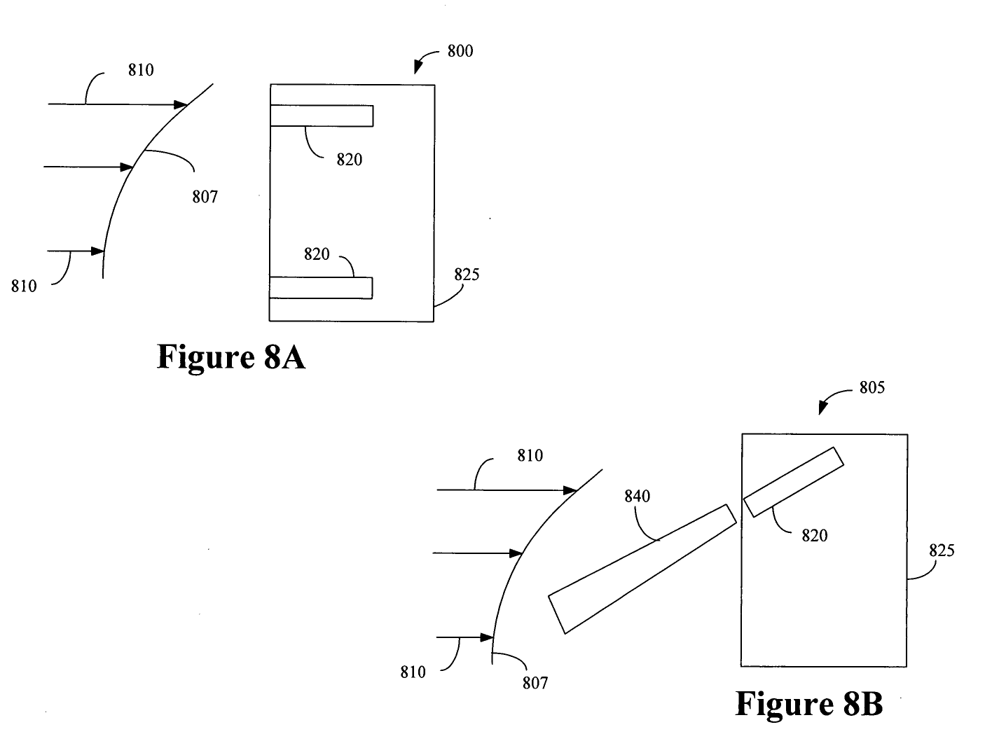

FIGS. 8A and 8B conceptually illustrate first and second embodiments of a system 800, 805 for determining a variation 807 of an ambient water velocity 810. For example, high winds may increase the ambient water velocity 810 near the surface. For another example, rip currents, which have very large current gradients in the vertical direction, may form near the surface. Rip currents frequently occur where fresh water meets salt water, e.g. outside river deltas. As discussed above, knowledge of the variation 807 may be used to improve the operational efficiency of a towed seismic array and the hydrofoil 800, 805. For example, rip current information may be particularly useful in avoiding streamer tangling. The measurement device 235 shown in FIG. 2 may be used, either as described in the above embodiments or with one or more modifications described below, to determine the variation 807.

In the first embodiment of the system 800, a plurality of measurement units 820 are deployed in or on a hydrofoil 825 to measure the ambient water velocity 810 at different depths. In the second embodiment of the system 805, at least one measurement unit 820 is deployed in or on the hydrofoil 825 so that the measurement beam 840 may sample the ambient water velocity 810 at different depths. For example, a Doppler log may be used to sample the ambient water velocity 810 at different depths. By measuring the ambient water velocity 810 at the different depths, either by measuring at different vertical positions on the hydrofoil 825 or using the measurement beam 840 that samples the ambient water velocity 810 at different depths, information regarding the variation of the ambient water velocity 810 (and/or the water currents) at different water depths may be extracted. For example, rip currents may be detected.

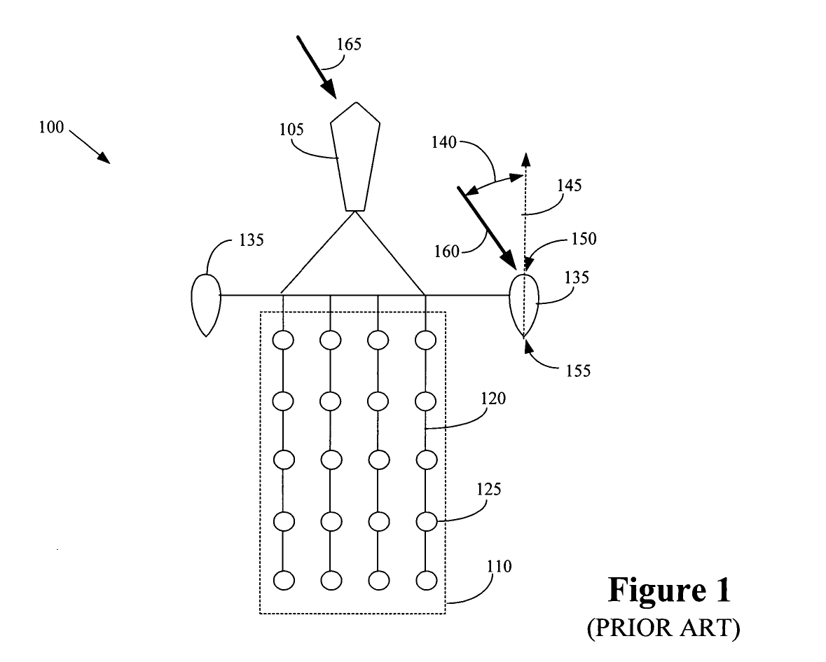

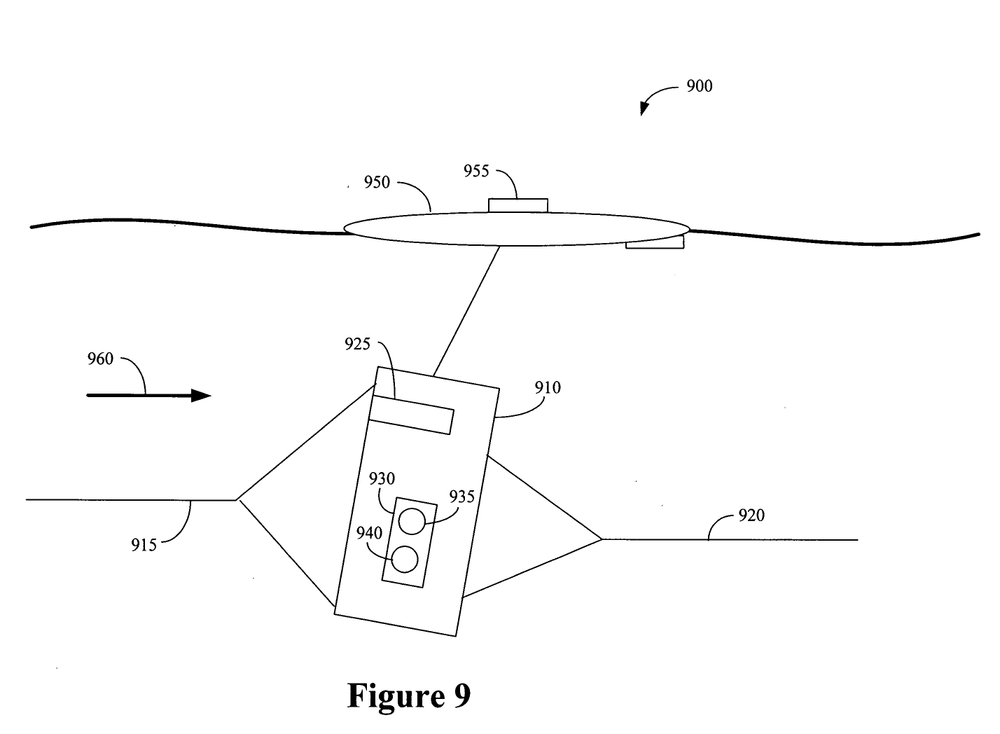

FIG. 9 conceptually illustrates one embodiment of a system 900 that may be used to determine a water current proximate a hydrofoil 910. In the illustrated embodiment, the hydrofoil 910 is towed by a lead-in 915, which may be coupled to a survey vessel (such as the survey vessel 105 shown in FIG. 1), and a bridle 917, which may comprise two chains in a split configuration. In the illustrated embodiment, the hydrofoil 910 also tows a streamer 920. As discussed in detail above, the hydrofoil 910 includes at least one measurement device 925. The hydrofoil 910 also includes a control system 930, which may include a tilt sensor 935 and a compass 940. The control system 930 determines an orientation of the hydrofoil 910. In one embodiment, the control system 930 may determine the orientation of the hydrofoil 910 using the tilt sensor 935 and/or the compass 940. In one embodiment, an ambient water velocity vector 960 may be decomposed into a horizontal and a vertical plane by correcting for a tilt of the hydrofoil 910 determined by the tilt sensor 935.

A float 950 is coupled to the hydrofoil 910. In the illustrated embodiment, a global positioning system receiver 955 is deployed in or on the float 950. The global positioning system receiver 955 may be used to determine a path of travel of the hydrofoil 910 relative to ground. However, the present invention is not limited to embodiments incorporating the global positioning system receiver 955. In alternative embodiments the hydrofoil 910 may include a different positioning system, such as a sub-sea acoustic positioning system used for streamer positioning. The water current component of the ambient water velocity 960 proximate the hydrofoil 910 may then be determined based upon the ambient water velocity 960 measured by the measurement device 925, the tilt and/or orientation of the hydrofoil 910, and/or the path of travel of the hydrofoil 910.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set-forth in the claims below.

1. A method, comprising:
deploying a measurement device in, on, or proximate to a hydrofoil; and
determining an ambient water velocity using the measurement device.

2. The method of claim 1, wherein determining the ambient water velocity comprises determining the ambient water velocity in an approximately undisturbed region proximate the hydrofoil.

3. The method of claim 2, wherein determining the ambient water velocity in the approximately undisturbed region comprises:
providing at least one Doppler beam to at least one column; and
determining the ambient water velocity in the at least one column using the at least one Doppler beam.

4. The method of claim 3, wherein determining the ambient water velocity in the approximately undisturbed region using the at least one Doppler beam comprises:
providing at least two Doppler beams to at least two columns;
determining at least two water velocities in the at least two columns using the at least two Doppler beams; and
determining a two-dimensional water velocity vector based on the at least two water velocities in the at least two columns.

5. The method of claim 3, wherein determining the ambient water velocity in the at least one column comprises determining the ambient water velocity at distances greater than about two chord lengths from the hydrofoil.

6. The method of claim 1, wherein determining the ambient water velocity comprises decomposing an ambient water velocity vector into a horizontal and a vertical plane by correcting for a tilt of the hydrofoil.

7. The method of claim 1, wherein determining the ambient water velocity comprises measuring a plurality of pressures approximately at a surface of the hydrofoil.

8. The method of claim 7, wherein determining the ambient water velocity comprises determining the ambient water velocity based upon the plurality of pressures.

9. The method of claim 8, wherein determining the ambient water velocity comprises:
calibrating a relationship between the plurality of pressures and the ambient water velocity; and
determining the ambient water velocity using the calibrated relationship.

10. The method of claim 1, further comprising determining a lift of the hydrofoil based on the determined ambient water velocity.

11. The method of claim 10, wherein determining the lift comprises determining an angle of attack of the hydrofoil based upon the ambient water velocity.

12. The method of claim 10, further comprising determining a normal operating range of the hydrofoil based upon the lift.

13. The method of claim 12, wherein determining the normal operating range of the hydrofoil comprises determining at least one of a wobble and a stall condition based upon the angle of attack.

14. The method of claim 10, further comprising controlling the lift of the hydrofoil to control a lateral position of a seismic streamer based upon a pre-defined track.

15. The method of claim 1, further comprising determining at least one current component of the ambient water velocity.

16. The method of claim 15, wherein determining the at least one current component comprises determining at least one of a tilt of the hydrofoil, an orientation of the hydrofoil, and a travel path of the hydrofoil relative to ground.

17. The method of claim 1, wherein determining the ambient water velocity comprises determining a variation in the ambient water velocity.

18. The method of claim 17, wherein determining the variation in the ambient water velocity comprises determining a variation of the ambient water velocity in a vertical direction.

19. An apparatus, comprising:
a hydrofoil; and
a measurement unit deployed in, on, or proximate to the hydrofoil and configured to determine an ambient water velocity.

20. The apparatus of claim 19, wherein the measurement unit comprises at least one Doppler log configured to determine the ambient water velocity in an approximately undisturbed region proximate the hydrofoil.

21. The apparatus of claim 20, wherein the at least one Doppler log is configured to determine the ambient water velocity in at least two columns using at least two Doppler beams.

22. The apparatus of claim 21, wherein the at least one Doppler log comprises more than one Doppler log deployed at different depths and configured to determine a variation in the ambient water velocity using at least one Doppler beam associated with each Doppler log.

23. The apparatus of claim 21, wherein the at least one Doppler log comprises at least one Doppler log configured to determine a variation in the ambient water velocity using at least one Doppler beam associated with each Doppler log, each Doppler beam being oriented at a selected angle to sample at different depths.

24. The apparatus of claim 20, wherein the at least one Doppler log is configured to determine the ambient water velocity at distances greater than about two chord lengths from the hydrofoil.

25. The apparatus of claim 19, wherein the measurement unit comprises a plurality of openings approximately at a surface of the hydrofoil, and wherein the measurement unit is configured to measure a plurality of pressures at the plurality of openings.

26. The apparatus of claim 25, wherein the measurement unit comprises a Pitot tube.

27. The apparatus of claim 25, wherein the plurality of openings are formed in the surface of the hydrofoil.

28. The apparatus of claim 25, wherein at least one of the plurality of openings is formed proximate a tail of the hydrofoil.

29. The apparatus of claim 25, wherein the plurality of openings are distributed along the surface of the hydrofoil and the measurement unit is configured to determine a variation in the ambient water velocity based upon the plurality of pressures.

30. The apparatus of claim 19, further comprising a processing unit configured to determine a lift of the hydrofoil based upon the ambient water velocity.

31. The apparatus of claim 30, wherein the processing unit is configured to determine an angle of attack of the hydrofoil based upon the ambient water velocity.

32. The apparatus of claim 30, wherein the processing unit is configured to determine at least one current component of the ambient water velocity.

33. The apparatus of claim 30, wherein the processing unit is configured to determine a normal operational range of the hydrofoil based upon the angle of attack.

34. The apparatus of claim 30, wherein the processing unit is configured to determine a stall condition based upon the angle of attack.

35. The apparatus of claim 30, wherein the processing unit is configured to control the lift of the hydrofoil to control a lateral position of a seismic streamer based upon a pre-defined track.

36. The apparatus of claim 19, further comprising a control system configured to determine at least one of a tilt and an orientation of the hydrofoil.

37. The apparatus of claim 36, wherein the control system comprises at least one of a tilt sensor and a compass.

38. The apparatus of claim 36, further comprising a positioning system configured to determine a path of travel of the hydrofoil.

39. The apparatus of claim 38, wherein the processing unit is configured to determine a water current component of the ambient water velocity based upon at least one of the ambient water velocity, the tilt of the hydrofoil, the orientation of the hydrofoil, and the path of travel of the hydrofoil.
